(19) United States
(12) Patent Application Publication
(10) Pub. No.: US 2022/0289186 A1
(43) Pub. Date: Sep. 15, 2022

(54) APPARATUS AND METHOD FOR CONTROLLING VEHICLE

(71) Applicants: Hyundai Motor Company, Seoul (KR); Kia Corporation, Seoul (KR)

(72) Inventor: Jaesik YANG, Seoul (KR)

(73) Assignees: Hyundai Motor Company, Seoul (KR); KIa Corporation, Seoul (KR)

(21) Appl. No.: 17/458,922

(22) Filed: Aug. 27, 2021

(30) Foreign Application Priority Data
Mar. 10, 2021 (KR) 10-2021-0031317

(51) Int. Cl. B60W 30/14; B60W 40/04; B60W 40/105; B60W 40/107; G06K 9/00

(52) U.S. Cl. CPC B60W 30/143; B60W 40/04; B60W 40/105; B60W 40/107; G06K 9/00825; B60W 2510/0657; B60W 2540/10; B60W 2540/12; B60W 2554/80

(57) ABSTRACT

A vehicle control apparatus, may include a driving environment sensor configured for obtaining information on a front vehicle; a communication portion configured for receiving road information; and a controller that utilizes the information on the front vehicle and the road information to determine an acceleration expectable state of a host vehicle, increases torque of a motor before a driver's input to an accelerator pedal of the host vehicle when the host vehicle is in the acceleration expectable state, and further increases the torque of the motor to be greater than a motor torque rise slope in the acceleration expectable state when the host vehicle is in the acceleration expectable state after increasing the torque of the motor.

### CROSS-REFERENCE TO RELATED APPLICATION

The present application claims priority to Korean Patent Application No. 10-2021-0031317 filed on Mar. 10, 2021, the entire contents of which is incorporated herein for all purposes by this reference.

### BACKGROUND OF THE INVENTION

### Field of the Invention

The present invention relates to an apparatus and method for controlling a vehicle which may reduce an impact of a vehicle at a time of backlash.

### Description of Related Art

Environment-friendly policies and improved fuel economy are becoming key aims in vehicle development due to global oil prices and emission regulations. Accordingly, companies that develop vehicles are making great efforts to develop technologies to reduce fuel consumption and exhaust gas to comply with environment-friendly policies and improve fuel economy.

The companies that develop vehicles are paying a lot of attention and effort to development of environment-friendly vehicle technology to solve problems caused by exhaust gas and achieve high fuel efficiency.

In the instant case, the environment-friendly vehicle is a futuristic vehicle that does not exhaust exhaust gas. The environment-friendly vehicle includes an electric vehicle that utilizes a motor to drive, a hybrid electric vehicle that drives by combining power of a motor and power of an engine, and a plug-in hybrid electric vehicle (PHEV) which may be charged with external electricity by installing a large-capacity high-voltage battery.

An electric vehicle is provided with a battery as a driving power source, and is driven by a motor that utilizes the present battery as a power source. While such an electric vehicle is accelerated, it is accelerated by receiving torque in the same direction as a driving direction from a motor, and while it is coasted or decelerated, it is decelerated by receiving torque in a direction opposite to the driving direction thereof.

However, when the direction of the torque of the motor is changed, an impact occurs on the vehicle due to backlash of the motor and a gear. To reduce the impact due to the backlash, a change amount in motor torque is controlled to be reduced when the direction of the torque is changed. However, when the change amount in the motor torque is reduced, the vehicle is accelerated or decelerated regardless of the will of the driver, resulting in a sense of heterogeneity.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus and method for controlling a vehicle which may reduce backlash.

Various aspects of the present invention are directed to providing an apparatus and method for controlling a vehicle which may accelerate the vehicle in advance.

Various aspects of the present invention are directed to providing a vehicle control apparatus, including: a driving environment sensor configured for obtaining information on a front vehicle; a communication portion configured for receiving road information; and a controller that utilizes the information on the front vehicle and the road information to determine an acceleration expectable state of a host vehicle, increases torque of a motor before a driver's input to an accelerator pedal of the host vehicle when the host vehicle is in the acceleration expectable state, and further increases the torque of the motor to be greater than a motor torque rise slope in the acceleration expectable state when the host vehicle is in the acceleration expectable state after increasing the torque of the motor.

The vehicle control apparatus may further include a brake pedal position sensor configured for measuring a position value of the brake pedal and electrically connected to the controller, when the controller concludes that there is no input from the driver to the brake pedal according to the position value of the brake pedal, the controller may be configured to determine the acceleration expectable state.

The vehicle control apparatus may further include a vehicle speed sensor configured for detecting a speed of a host vehicle, wherein when a speed of the host vehicle is greater than or equal to a threshold vehicle speed, the controller may be configured to determine the acceleration expectable state.

The driving environment sensor may detect presence or absence of the front vehicle, and when the controller concludes that there is no front vehicle according to a result of detecting presence or absence of the front vehicle by the driving environment sensor, the controller may be configured to determine the acceleration expectable state.

The driving environment sensor may detect a relative speed of the host vehicle with respect to the front vehicle, and when the controller concludes that the relative speed is greater than or equal to a threshold value, the controller may be configured to determine the acceleration expectable state.

The road information may include traffic signals, traffic conditions, and surrounding vehicle driving conditions.

The vehicle control apparatus may further include an accelerator position sensor configured for detecting the driver's input to the accelerator pedal and electrically connected to the controller, wherein after increasing the torque of the motor, when the controller concludes that there is the input of the driver to the accelerator pedal, there is no input of the driver to the brake pedal, and there is no manipulation of the driver to a turn signal lamp of the host vehicle, the controller may be configured to determine that the host vehicle is in an acceleration state.

Various aspects of the present invention are directed to providing a vehicle control method, including: obtaining, by a driving environment sensor, information on a front vehicle; receiving, by a communication portion, road information; determining, by a controller electrically connected to the driving environment sensor and the communication portion, an acceleration expectable state of a host vehicle by use of the information on the front vehicle received from the driving environment sensor and the road information received from the communication portion; increasing, by the controller, torque of a motor before a driver's input to an accelerator pedal of the host vehicle when the host vehicle is in the acceleration expectable state; and further increasing, by the controller, the torque of the motor to be greater than a motor torque rise slope in the acceleration expectable state when the host vehicle is in an acceleration state.

The determining of the acceleration expectable state of the vehicle may include determining, by the controller, the acceleration expectable state when there is no input from the driver to a brake pedal of the host vehicle.

The determining of the acceleration expectable state of the vehicle may include determining, by the controller, the acceleration expectable state when a speed of the host vehicle is greater than or equal to a threshold vehicle speed.

The vehicle control method may further include detecting, by the driving environment sensor, presence or absence of the front vehicle, wherein the determining of the acceleration expectable state of the vehicle may include determining, by the controller, the acceleration expectable state when there is no front vehicle.

The vehicle control method may further include detecting, by the driving environment sensor, a relative speed of the host vehicle with respect to the front vehicle, wherein the determining of the acceleration expectable state of the vehicle may include determining, by the controller, the acceleration expectable state when the relative speed is greater than or equal to a threshold value.

The road information may include traffic signals, traffic conditions, and surrounding vehicle driving conditions.

The further increasing of the torque of the motor may include further increasing, by the controller, the torque of the motor when there is an input of the driver to the accelerator pedal, there is no input of the driver to the brake pedal, and there is no manipulation of the driver to a turn signal lamp of the host vehicle.

A vehicle according to various exemplary embodiments of the present invention includes the vehicle control apparatus according to the exemplary embodiment of the present invention.

A program stored in a computer-readable medium according to an exemplary embodiment executes the vehicle control method according to the exemplary embodiment of the present invention.

According to the embodiments, it is possible to reduce an acceleration delay of a vehicle.

According to the embodiments, it is possible to reduce an impact during acceleration.

According to the embodiments, it is possible to accelerate a vehicle by reflecting a driver's will.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram of a vehicle control apparatus according to various exemplary embodiments of the present invention.

FIG. 2 illustrates a flowchart of a vehicle control method according to various exemplary embodiments of the present invention.

FIG. 3A, FIG. 3B and FIG. 3C illustrate exemplary diagrams when acceleration of a vehicle is predicted according to a vehicle control method of various exemplary embodiments of the present invention.

FIG. 4 illustrates graphs of torque and acceleration according to a vehicle control method of various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various embodiments of the present specification will be described with reference to the accompanying drawings. However, it may be understood that technology described in the present specification is not limited to a specific embodiment and includes various modifications, equivalents, and/or alternatives of an exemplary embodiment of the present specification. With regard to the description of the drawings, similar reference numerals may be used to refer to similar elements.

In the present specification, an expression such as “have,” “may have,” “comprise,” or “may comprise” indicates existence of a corresponding characteristic (e.g., constituent elements such as a numerical value, function, operation, or component) and does not exclude the presence of another characteristic.

In the present specification, an expression such as “A or B”, “at least one of A or/and B”, or “one or more of A or/and B” may include all possible combinations of together listed items. For example, “A or B,” “at least one of A and B,” or “one or more of A or B” may indicate all of (1) a case of including at least one A, (2) a case of including at least one B, and (3) a case of including both at least one A and at least one B.

An expression such as “first” and “second” used in the present specification may indicate various constituent elements regardless of order and/or importance, is used for distinguishing a constituent element from another constituent element, and does not limit corresponding constituent elements. For example, a first user device and a second user device may represent another user device regardless of order and/or importance. For example, a first constituent element may be referred to as a second constituent element without deviating from the scope described in the present specification, and similarly, a second constituent element may be referred to as a first constituent element.

When it is described that a constituent element (e.g., a first constituent element) is “(operatively or communicatively) coupled with/to” or is “connected to” another constituent element (e.g., a second constituent element), it should be understood that the constituent element may be directly connected to the other constituent element or may be connected to the other constituent element through another constituent element (e.g., a third constituent element). However, when it is described that a constituent element (e.g., a first constituent element) is “directly connected” or is “directly accessed” to another constituent element (e.g., a second constituent element), it may be understood that another constituent element (e.g., a third constituent element) does not exist between the constituent element and the other constituent element.

An expression “configured to” used in the present specification may be interchangeably used with, for example, “suitable for”, “having the capacity to”, “designed to”, “adapted to”, “made to”, or “capable of” according to a situation. A term “configured to” does not always mean “specifically designed to” in hardware. Alternatively, in any situation, an expression “device configured to” may mean that the device is “capable of” being configured together with another device or component. For example, a “processor configured to perform phrases A, B, and C” may be a generic-purpose processor (e.g., a CPU or application processor) that executes an exclusive processor (e.g., an embedded processor) for performing a corresponding operation or at least one software program stored at a memory device to perform a corresponding operation.

Terms used in the present specification are used for describing a specific embodiment and do not limit a range of another exemplary embodiment of the present invention. Unless the context otherwise clearly indicates, words used in the singular include the plural, and the plural includes the singular. Terms used here including a technical or scientific term have the same meaning as that which may be generally understood by a person of common skill in the art. Terms defined in a general dictionary among terms used in the present specification may be analyzed as having the same meaning as or a meaning similar to that in a context of related technology, and unless it is clearly defined in the present specification, the term is not analyzed as having an ideal or excessively formal meaning. In some cases, a term defined in the present specification cannot be analyzed to exclude the exemplary embodiments of the present specification.

It is understood that the term “vehicle” or “vehicular” or other similar terms as used herein is inclusive of motor vehicles in general such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g., fuel determined from resources other than petroleum).

Hereinafter, a vehicle control apparatus and method according to exemplary embodiments will be described with reference to necessary drawings.

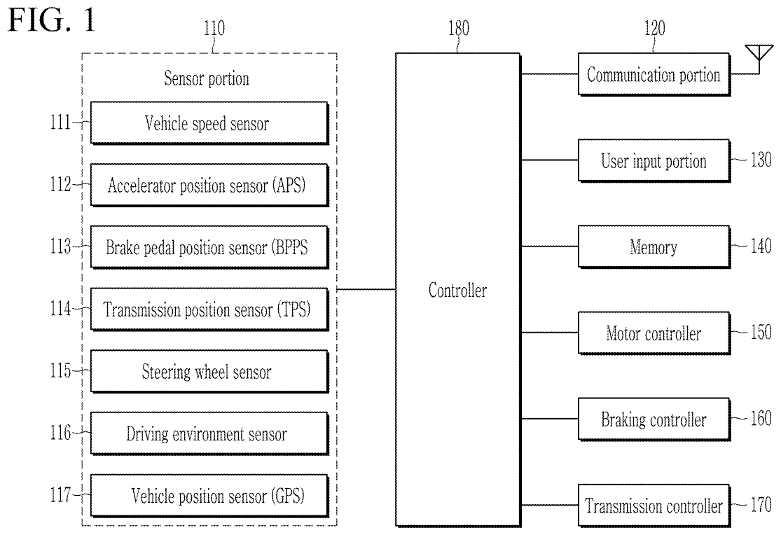

FIG. 1 illustrates a block diagram of a vehicle control apparatus according to various exemplary embodiments of the present invention.

Referring to FIG. 1, a vehicle control apparatus may include a sensor portion 110, a communication portion 120, a user input portion 130, a memory 140, a motor controller 150, a brake controller 160, a transmission controller 170, and a controller 180. Furthermore, when the vehicle is a hybrid electric vehicle, the vehicle control apparatus may further include an engine controller that is configured to control an engine.

The sensor portion 110 may include a vehicle speed sensor 111, an accelerator position sensor (APS) 112, a brake pedal position sensor (BPPS) 113, a transmission position sensor (TPS) 114, a steering wheel sensor 115, a driving environment sensor 116, and a vehicle position sensor 117.

The vehicle speed sensor 111 may detect a vehicle speed. For example, the vehicle speed sensor may be mounted on a vehicle's wheel.

The accelerator position sensor 112 measures a degree to which the driver depresses the accelerator pedal. That is, the accelerator position sensor 112 measures a position value of the accelerator pedal (the degree to which the accelerator pedal is depressed) to provide a signal of the measured position value to the controller 180. When the accelerator pedal is fully depressed, the position value of the accelerator pedal may be 100%, and when the accelerator pedal is not depressed, the position value of the accelerator pedal may be 0%. Instead of the accelerator position sensor 112, a throttle valve opening detector mounted in an intake passage may be used.

The brake pedal position sensor 113 measures a degree to which the driver depresses the brake pedal. That is, the brake pedal position sensor 113 measures a position value of the brake pedal (the degree to which the brake pedal is depressed) to transmit a signal of the measured position value to the controller 180. When the brake pedal is fully depressed, the position value of the brake pedal may be 100%, and when the brake pedal is not depressed, the position value of the brake pedal may be 0%.

The transmission position sensor 114 detects a gear shifting position, and the steering wheel sensor 115 detects a steering state of the host vehicle.

The driving environment sensor 116 detects driving environment information and vehicle state information of a road on which the vehicle is driving. The driving environment sensor 116 obtains driving environment information through various sensors such as a camera, a radio detecting and ranging (radar), a light detection and ranging (LiDAR), and an ultrasonic wave sensor.

The driving environment sensor 116 extracts shape information and distance information such as lanes, speed limits, traffic signs, surrounding vehicles, pedestrians, and traffic lights from image information obtained through the camera. Furthermore, the driving environment sensor 116 may obtain distance and spatial information for omnidirectional objects (vehicles, pedestrians, and/or obstacles, etc.) through the radar, the LiDAR, and the ultrasonic wave sensor.

The vehicle position sensor 117 measures a vehicle's current position. The vehicle position sensor 117 may measure the vehicle position by use of at least one or more of a global positioning system (GPS), dead reckoning (DR), a differential GPS (DGPS), and a planet carrier phase differential GPS (CDGPS).

The communication portion 120 communicates with a server through a network. The communication portion 120 may communicate with surrounding vehicles and/or road infrastructure. The communication portion 120 may use communication technologies such as wireless Internet, mobile communication, and/or vehicle to everything (V2X). As the wireless Internet technology, the wireless LAN (WLAN) (WiFi), the wireless broadband (WiBro), and/or the Worldwide Interoperability for Microwave Access (WiMAX) may be used, and as the mobile communication technology, the code division multiple access (CDMA), the global system for mobile communication (GSM), the long term evolution (LTE), and/or the LTE-Advanced may be used. As the V2X communication technology, the vehicle-to-vehicle (V2V) communication, the vehicle-to-infrastructure (V2I) communication, the vehicle-to-nomadic devices (V2N) communication, and/or the in-vehicle network (IVN) communication may be applied.

The communication portion 120 may receive surrounding vehicle information from surrounding vehicles, and may receive traffic state information from surrounding traffic equipment.

The surrounding vehicle information may include surrounding vehicle ID, surrounding vehicle Global Positioning System (GPS) position information, surrounding vehicle state information, and surrounding vehicle path history information, but is not limited thereto.

The surrounding vehicle state information may include vehicle speed information, heading information, brake operation information, and turn signal information, but is not limited thereto.

The traffic state information may include traffic light state information. Here, the traffic light state information may include a running state, a stop notice state, and a stop state, but is not limited thereto.

The user input portion 130 generates input data (for example, autonomous driving mode operation or release) according to the user's manipulation. The user input portion 130 may be implemented as a keyboard, a keypad, a button, a jog shuttle, a switch, a touch pad, and/or a touch screen. For example, the user input portion 130 generates a signal indicating activation of a specific control function (for example, lane maintenance, obstacle avoidance, collision avoidance, lane change, or acceleration/deceleration control) according to user input.

The memory 140 may store software programmed for the controller 180 to perform a predetermined operation, and may store input/output data. Furthermore, the memory 140 may store a precision map in a database format. The precision map may be automatically updated every predetermined transmission period or manually updated by the user. Furthermore, the memory 140 may store map information and road information mapped to a driving route provided from a server. The map information includes precision map and road information. The road information includes information such as autonomous driving levels, road attributes, traffic signals, traffic conditions, road conditions, traffic signs, major buildings, and driving conditions of surrounding vehicles, for each road section (link).

The memory 140 may store vehicle identification information, and a maximum autonomous driving level (autonomous driving support level) which may be supported by the host vehicle. The memory 140 may store reliability calculation algorithms, and software programmed to perform specific control functions to perform autonomous driving of the host vehicle.

The memory 140 may be implemented as at least one or more of storage mediums (recording mediums) such as a flash memory, a hard disk, a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), a register, a detachable disk, and a web storage.

The motor controller 150 controls an operation of a motor according to a motor torque command determined by the controller 180.

The brake controller 160 controls the vehicle's deceleration. The braking controller 160 controls a braking pressure according to a brake pedal position or a braking pressure according to control of the controller 180.

The transmission controller 170 is configured to shift a gear (shifting stage) of the host vehicle. The transmission controller 170 may be implemented as an electronic shifter or an electric shifter (shift by wire, SBW).

The controller 180 controls an operation (acceleration and deceleration, and/or braking) of the vehicle based on driving environment information and vehicle state information detected by the sensor portion 110. The controller 180 may be implemented as at least one or more of an application specific integrated circuit (ASIC), a digital signal processor (DSP), a programmable logic device (PLD), a field programmable Gate Array (FPGA), a central processing unit (CPU), a microcontroller, and a microprocessor.

The controller 180 obtains vehicle information from one or more sensors mounted on the vehicle in addition to the sensors described above in the sensor portion 110, and/or an electronic control unit (ECU) other than the various controllers 150, 160, and 170. The one or more sensors may include an impact sensor, a steering angle sensor, and an acceleration sensor. The controller 180 may obtain vehicle information (for example, airbag deployment, door opening, or door closing) from various electronic control units (ECU) connected through the IVN. The IVN is implemented as a controller area network (CAN), a media oriented systems transport (MOST) network, a local interconnect network (LIN), and/or an X-by-wire (FlexRay).

The controller 180 may control the operation of the motor by determining whether the vehicle is accelerating while the vehicle is running. For example, when it is determined that vehicle acceleration is to be performed based on data obtained from the sensor portion 110, the controller 180 may reduce a torque regeneration amount of the motor being regenerated, and may increase torque of the motor before operating the accelerator pedal.

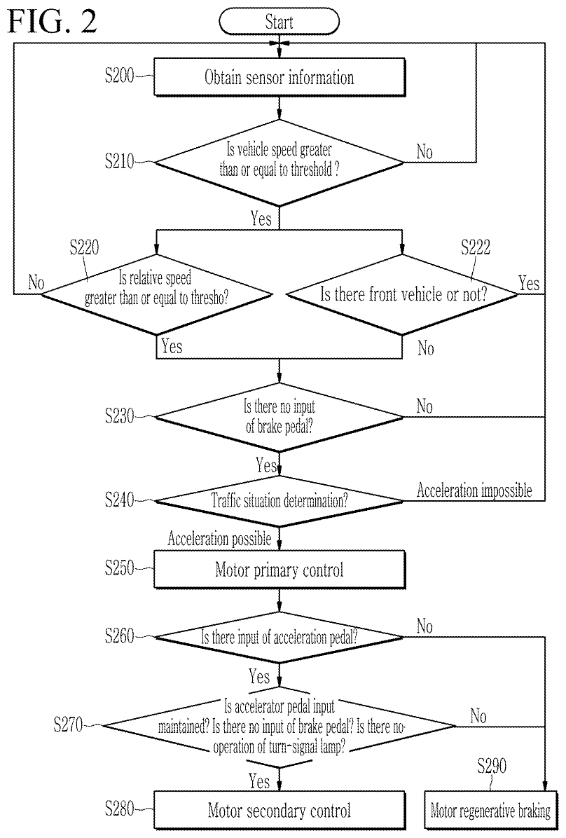

Hereinafter, referring to FIG. 2, a vehicle control method according to various exemplary embodiments of the present invention will be described.

FIG. 2 illustrates a flowchart of a vehicle control method according to various exemplary embodiments of the present invention.

The controller 180 obtains information detected by the sensor portion 110 and information received from the communication portion 120 (S200). For example, the controller 180 obtains a vehicle speed, a relative speed with the front vehicle, presence or absence of the front vehicle, and a position of the brake pedal from the sensor portion 110, and obtains traffic conditions received from the server, the surrounding vehicle, or the surrounding equipment through the communication portion 120.

The controller 180 determines whether the vehicle speed is greater than or equal to a threshold vehicle speed (S210). For example, the controller 180 may determine whether the vehicle speed is 20 km/h or more. Here, the threshold vehicle speed may be set to various speeds, and is not limited to the above example.

When the vehicle speed is greater than or equal to the threshold value, the controller 180 determines whether the relative speed of the host vehicle with the front vehicle is greater than or equal to a threshold value (S220). Furthermore, when the vehicle speed is greater than or equal to the threshold value, the controller 180 determines whether there is a front vehicle or not (S222).

The controller 180 may determine a distance between the front vehicle and the host vehicle and a relative speed between the front vehicle and the host vehicle, through the driving environment sensor 116. For example, the driving environment sensor 116 may measure a relative inter-vehicle distance between the front vehicle and the host vehicle by use of a front radar signal. The driving environment sensor 116 may utilize a front radar for smart cruise control (SCC) or various sensors such as ultrasonic wave and laser sensors.

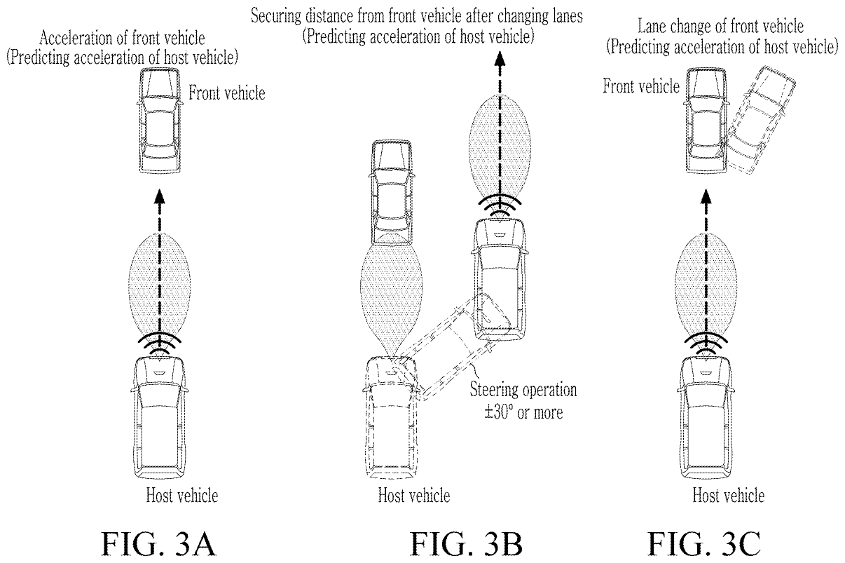

An exemplary embodiment in connection with step S220 and step S222 will be described with reference to FIG. 3.

FIG. 3 illustrates an exemplary diagram when acceleration of a vehicle is predicted according to a vehicle control method of various exemplary embodiments of the present invention.

As shown in FIG. 3A, when the relative speed of the front vehicle increases to be 0 km/h or more, the controller 180 may predict that the driver of the host vehicle will accelerate due to acceleration of the front vehicle. Here, the threshold relative speed may be set to various speeds, but is not limited to the above example.

When as shown in FIG. 3B, after the steering wheel angle of the vehicle is manipulated to a predetermined angle (±30°) or more, the front vehicle is not detected, or when as shown in FIG. 3C, the front vehicle is not detected due to a lane change of the front vehicle, the controller 180 may predict that the driver of the host vehicle will accelerate.

Next, when the relative speed of the front vehicle is greater than or equal to the threshold relative speed, or when the controller concludes that there is no front vehicle according to a result of detecting presence or absence of the front vehicle by the driving environment sensor, the controller 180 determines whether there is no input of the brake pedal (S230). For example, the controller 180 may determine whether the position value of the brake pedal exceeds zero. Alternatively, the controller 180 may determine whether the position value of the brake pedal is decreasing.

When there is no driver input to the brake pedal, that is, when it is determined that the position value of the brake pedal is 0 or the position value of the brake pedal is decreasing, the controller 180 determines the traffic condition (S240).

When the front traffic condition is smooth and the traffic light condition is the driving condition, the controller 180 may determine that the acceleration is possible (that is, the vehicle is in an acceleration expectable state). The front traffic condition and the traffic light condition may be determined by use of road information received from the communication portion 120, and/or may be determined from the driving environment sensor 116.

For example, when the relative speed of the front vehicles detected by the driving environment sensor 116 increases, the controller 180 may determine that the traffic condition in front is smooth. Furthermore, the controller 180 may determine that the state of the traffic light is in the running state when a traffic light emitting green is detected in the image captured by the camera.

When it is determined that the acceleration is possible, the controller 180 controls the motor (S250). The controller 180 reduces the regeneration amount of the motor, and increases the torque of the motor.

Thereafter, the controller 180 determines whether there is an accelerator pedal input within a predetermined time period (S260). Accordingly, the controller 180 determines whether the accelerator pedal input is maintained, whether there is no input of the brake pedal, and whether there is no operation of a turn-signal lamp (S270).

When the accelerator pedal input is maintained, there is no brake pedal input, and there is no operation of the turn-signal lamp, the controller 180 controls the motor again. When the accelerator pedal input is maintained, there is no brake pedal input, and there is no operation of the turn-signal lamp, the controller 180 may determine that the host vehicle is in an acceleration state, and may control a torque rise slope of the motor to be higher than a torque rise slope in the acceleration expectable state.

When the accelerator pedal input is not maintained, there is an input of the brake pedal, or there is an operation of the turn-signal lamp, the controller 180 starts regenerative braking of the motor (S290).

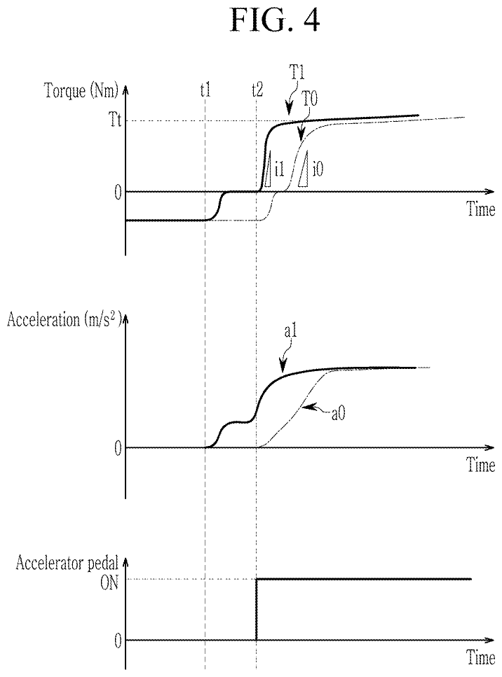

An exemplary embodiment in connection with step S250 to step S280 will be described with reference to FIG. 4.

FIG. 4 illustrates graphs of torque and acceleration according to a vehicle control method of various exemplary embodiments of the present invention.

As shown in FIG. 4, in the conventional case, after the driver operates the accelerator pedal (time point t2), the torque T0 of the motor increases.

According to various exemplary embodiments of the present invention, the controller 180 outputs a motor torque command for increasing the torque of the motor to the motor controller 150 (S250). Accordingly, torque T1 of the motor increases at time point t1 when the driver does not operate the accelerator pedal. The torque of the motor that has risen before operating the accelerator pedal has a value (for example, 0 Nm) within a range outside a backlash range.

Next, when the driver operates the accelerator pedal at time point t2, the controller 180 outputs a motor torque command for increasing a torque increase slope i1 of the motor to the motor controller 150 (S280). Since the torque rise slope i1 of the motor is out of the regeneration amount reduction and backlash region, during normal driving, the torque rise slope i1 may rise more steeply than a motor torque rise slope i0 according to the accelerator pedal input. Furthermore, the torque rise slope i1 of the motor may be steeper than the torque rise slope in step S250.

According to various exemplary embodiments of the present invention, since the vehicle may be accelerated in a state outside the backlash region in advance, it is possible to be accelerated faster than before without an impact and acceleration delay (a1>a0).

It may be appreciated that various embodiments of the present invention and the terms used therein are not intended to limit the technological features set forth herein to various exemplary embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or portion thereof, configured to perform one or more functions. For example, according to various exemplary embodiments of the present invention, the module may be implemented in a form of an application-specific integrated circuit (ASIC).

Various embodiments as set forth herein may be implemented as software (e.g., the program) including one or more instructions that are stored in a storage medium (e.g., internal memory or external memory) which is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in a form of a non-transitory storage medium. The term “non-transitory” simply means that the storage medium is a tangible device, and does not include a signal (e.g., an electromagnetic wave), but the present term does not differentiate between where data is semi-permanently stored in the storage medium and where the data is temporarily stored in the storage medium.

According to various exemplary embodiments of the present invention, a method according to various embodiments of the present invention may be included and provided in a computer program product. The computer program product may be traded as a product between a seller and a buyer. The computer program product may be distributed in a form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be conducted sequentially, in parallel, repeatedly, or heuristically, or one or more of the operations may be executed in a different order or omitted, or one or more other operations may be added.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle control apparatus, comprising:
a driving environment sensor configured for obtaining information on a front vehicle;
a communication portion configured for receiving road information; and
a controller electrically connected to the driving environment sensor and the driving environment sensor and configured for utilizing the information on the front vehicle and the road information to determine an acceleration expectable state of a host vehicle, for increasing torque of a motor before a driver's input to an accelerator pedal of the host vehicle when the host vehicle is in the acceleration expectable state, and for further increasing the torque of the motor to be greater than a motor torque rise slope in the acceleration expectable state when the host vehicle is in the acceleration expectable state after increasing the torque of the motor.

2. The vehicle control apparatus of claim 1, further including
a brake pedal position sensor configured for measuring a position value of a brake pedal and electrically connected to the controller,
wherein when the controller concludes that there is no input from the driver to the brake pedal according to the position value of the brake pedal, the controller is configured to determine the acceleration expectable state.

3. The vehicle control apparatus of claim 1, further including
a vehicle speed sensor configured for detecting a speed of the host vehicle and electrically connected to the controller,
wherein when the controller concludes that the speed of the host vehicle is greater than or equal to a threshold vehicle speed according to the detected speed of the vehicle speed sensor, the controller is configured to determine the acceleration expectable state.

4. The vehicle control apparatus of claim 1,
wherein the driving environment sensor is configured to detect presence or absence of the front vehicle, and
wherein when the controller concludes that there is no front vehicle according to a result of detecting presence or absence of the front vehicle by the driving environment sensor, the controller is configured to determine the acceleration expectable state.

5. The vehicle control apparatus of claim 1,
wherein the driving environment sensor is configured to detect a relative speed of the host vehicle with respect to the front vehicle, and
wherein when the controller concludes that the relative speed is greater than or equal to a threshold value, the controller is configured to determine the acceleration expectable state.

6. The vehicle control apparatus of claim 1, wherein the road information includes traffic signals, traffic conditions, and surrounding vehicle driving conditions.

7. The vehicle control apparatus of claim 1, further including
an accelerator position sensor configured for detecting the driver's input to the accelerator pedal and electrically connected to the controller,
wherein after increasing the torque of the motor, when the controller concludes that there is the input of the driver to the accelerator pedal, there is no input of the driver to a brake pedal, and there is no manipulation of the driver to a turn signal lamp of the host vehicle, the controller is configured to determine that the host vehicle is in an acceleration state.

8. A vehicle control method, comprising:
obtaining, by a driving environment sensor, information on a front vehicle;
receiving, by a communication portion, road information;
determining, by a controller electrically connected to the driving environment sensor and the communication portion, an acceleration expectable state of a host vehicle by use of the information on the front vehicle received from the driving environment sensor and the road information received from the communication portion;
increasing, by the controller, torque of a motor before a driver's input to an accelerator pedal of the host vehicle when the controller concludes that the host vehicle is in the acceleration expectable state; and
further increasing, by the controller, the torque of the motor to be greater than a motor torque rise slope in the acceleration expectable state when the controller concludes that the host vehicle is in an acceleration state.

9. The vehicle control method of claim 8, wherein the determining of the acceleration expectable state of the host vehicle includes determining, by the controller, the acceleration expectable state when the controller concludes that there is no input from the driver to a brake pedal of the host vehicle.

10. The vehicle control method of claim 8, wherein the determining of the acceleration expectable state of the host vehicle includes determining, by the controller, the acceleration expectable state when the controller concludes that a speed of the host vehicle is greater than or equal to a threshold vehicle speed.

11. The vehicle control method of claim 8, further including:
detecting, by the driving environment sensor, presence or absence of the front vehicle,
wherein the determining of the acceleration expectable state of the host vehicle includes determining, by the controller, the acceleration expectable state when the controller concludes that there is no front vehicle.

12. The vehicle control method of claim 8, further including:
detecting, by the driving environment sensor, a relative speed of the host vehicle with respect to the front vehicle,
wherein the determining of the acceleration expectable state of the host vehicle includes determining, by the controller, the acceleration expectable state when the controller concludes that the relative speed is greater than or equal to a threshold value.

13. The vehicle control method of claim 8, wherein the road information includes traffic signals, traffic conditions, and surrounding vehicle driving conditions.

14. The vehicle control method of claim 8, wherein the further increasing of the torque of the motor includes:
further increasing, by the controller, the torque of the motor when the controller concludes that there is the driver's input to the accelerator pedal, there is no input of the driver to a brake pedal of the host vehicle, and there is no manipulation of the driver to a turn signal lamp of the host vehicle.

15. A vehicle including the vehicle control apparatus of claim 1.

16. A program stored in a non-transitory computer-readable medium, executing the vehicle control method of claim 8.

17. A non-transitory computer readable storage medium on which a program for performing the method of claim 8 is recorded.
